(19) United States
(12) Patent Application Publication
(10) Pub. No.: US 2016/0193653 A1
(43) Pub. Date: Jul. 7, 2016

(54) Forming a Metal Component

(71) Applicant: CASTINGS TECHNOLOGY INTERNATIONAL LTD, Sheffield, South Yorkshire (GB)

(72) Inventors: Michael Cornelius Ashton, Sheffield, South Yorkshire (GB); James Michael Collins, Doncaster (GB)

(21) Appl. No.: 14/909,520

(22) PCT Filed: Aug. 1, 2014
(86) PCT No.: PCT/GB2014/000303

§ 371 Date: Feb. 2, 2016

(30) Foreign Application Priority Data
Aug. 2, 2013 (GB) 13 13 849.0
Nov. 15, 2013 (GB) 13 20 168.6
Nov. 15, 2013 (GB) 13 20 171.0

(51) Int. Cl. B22D 23/06; F27D 7/06; B22D 18/06; F27D 11/06; B22C 1/00; B22C 9/06

(52) U.S. Cl. CPC B22D 23/06; B22C 1/00; B22C 9/061; B22D 18/06; F27D 11/06; F27D 7/06; F27D 2007/066

(57) ABSTRACT

The forming of the metal component is disclosed, in which feed material is initially in a powdered state. A sacrificial positive model (102) of a component is created and a negative mould (104) is built around said positive model from a material having a melting point higher than the melting point of the metal from which the component is to be formed. The sacrificial positive model is removed from the negative mould. Feed material (108) of metal powder is deployed into the mould and the metal powder is heated to a temperature higher than the melting point of the metal powder, so as to cause the metal powder to melt within the mould.

### CROSS REFERENCE TO RELATED APPLICATIONS

This application claims priority from United Kingdom Patent Application No. 13 13 849.0, filed Aug. 2, 2013, United Kingdom Patent Application No. 13 20 168.6, filed Nov. 15, 2013, and United Kingdom Patent Application No. 13 20 171.0, filed Nov. 15, 2013, the entire disclosures of which are incorporated herein by reference in their entirety.

### BACKGROUND OF THE INVENTION

1. Field of the Invention

The present invention relates to a method of forming a metal component from a powdered feed material.

The present invention also relates to an apparatus for forming a metal component from a powdered feed material.

2. Description of the Related Art

Powder metallurgy is a known method for forming a metal component, from a powdered feed material. In a known hot isostatic pressing (HIP) process, powder is shaped in a steel mould to which both pressure and temperature are applied. Typically, argon gas is used to provide the isostatic pressure which may range from 50 megapascal to 300 megapascal. During this process, the temperature of the material is raised so as to sinter the powder and cause the particles to fuse together. However, known powder metallurgy is limited in terms of the size of products that can be produced and also in terms of the complexity of their shape. Furthermore, it is a costly and time consuming process. It is difficult to scale and often impossible to produce products having the required size and complexity when competing against products produced by a more conventional casting process.

### BRIEF SUMMARY OF THE INVENTION

According to a first aspect of the present invention, there is provided a method of the aforesaid type for forming a metal component from a powdered feed material, comprising the steps of: creating a negative mould of a component from a ceramics material having a melting point that is higher than the melting point of said powdered feed material; deploying said feed material of metal powder into said mould; locating said mould in a vacuum chamber having an induction heating system, said induction heating system comprising a source of electromagnetic energy and a granular susceptance material; and heating said mould using said induction heating system to a temperature higher than the melting point of the metal powder so as to melt the metal powder within the mould; wherein said granular susceptance material absorbs the energy of the induction field generated by said source of electromagnetic energy and radiates infra-red energy towards the ceramic mould. In an embodiment, during the deployment of the feed material into the mould, a degree of vibration may be introduced to facilitate the dispersal of the feed material within the mould.

According to a second aspect of the present invention, there is provided an apparatus for forming a metal component from a powdered feed material, comprising: a negative mould of a component comprised of a ceramics material having a melting point higher than the melting point of said powdered feed material contained therein; and a vacuum chamber for receiving said mould, the vacuum chamber being having an induction heating system comprising a source of electromagnetic energy and a granular susceptance material; wherein said granular susceptance material configured to absorb the energy of the induction field generated by said source of electromagnetic energy and radiate infra-red energy towards the ceramic mould.

### BRIEF DESCRIPTION OF THE DRAWINGS

FIG. 1 shows a method of forming a metal component;

FIG. 2 shows procedures for the creation of a positive model;

FIG. 3 shows the addition of layers to produce a mould;

FIG. 4 shows the deployment of feed material;

FIG. 5 shows apparatus for forming a metal component;

FIG. 6 shows a cross section of a feeder section;

FIG. 7 shows the mould of FIG. 5 after being loaded with metal powder;

FIG. 8 shows the mould of FIG. 7 with liquid metal;

FIG. 9 shows a partial cross section view of the mould;

FIG. 10 shows the view of FIG. 9 after further cooling;

FIG. 11 shows a mould of an alternative configuration;

FIG. 12 illustrates a heating system;

FIG. 13 shows an alternative embodiment of the mould; and

FIG. 14 shows a mould immersed in a granular susceptance material.

### DETAILED DESCRIPTION OF EXAMPLE EMBODIMENTS

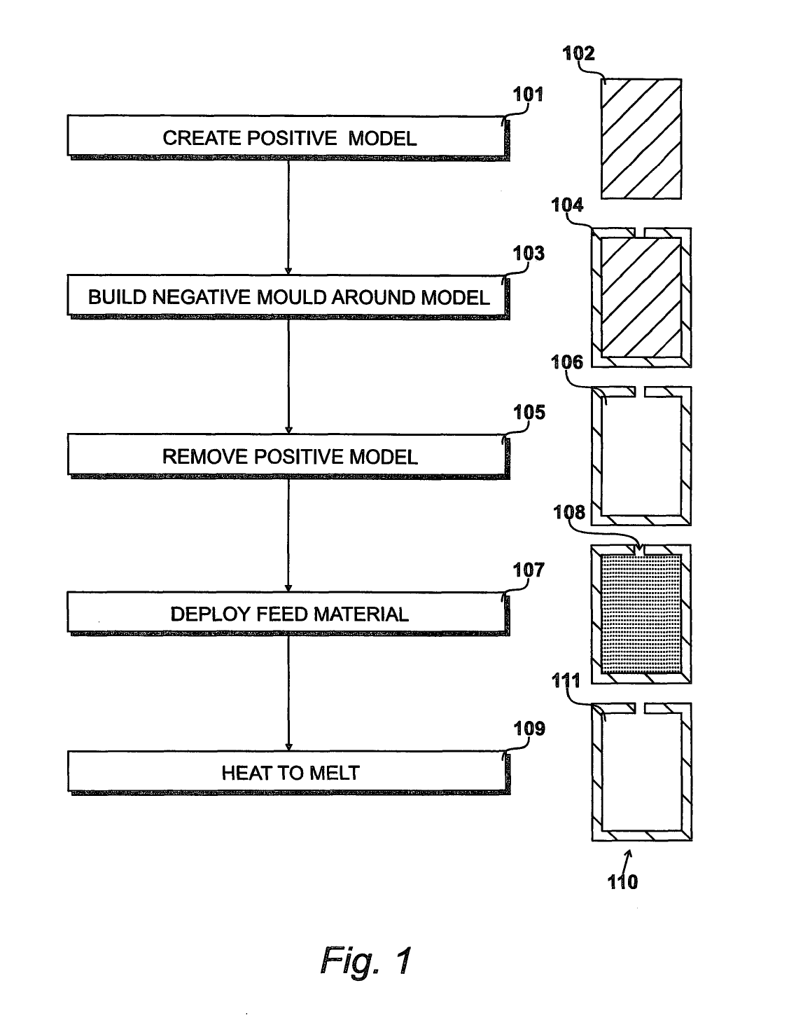

### FIG. 1

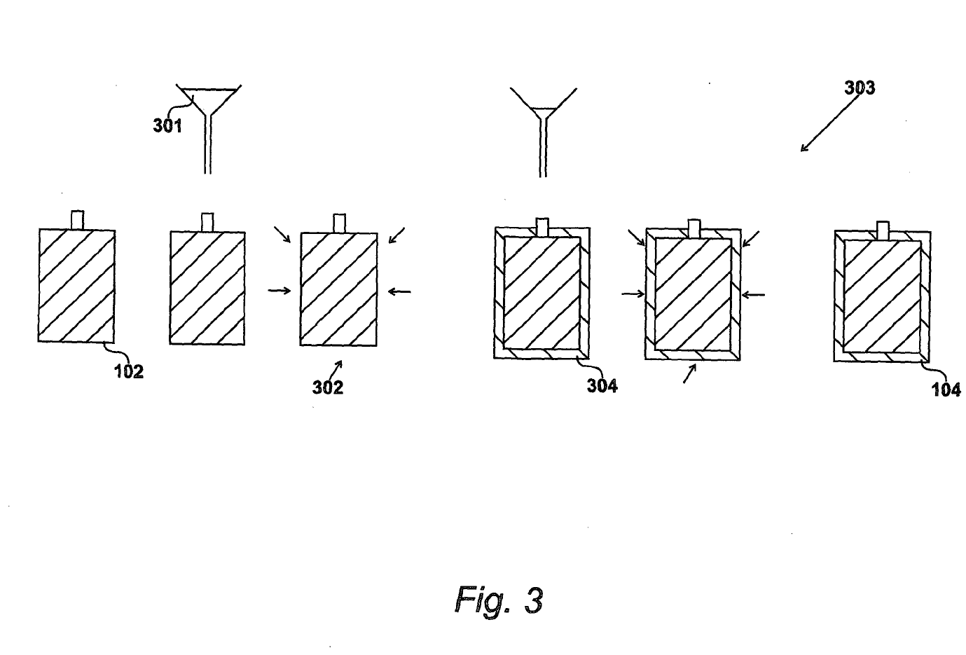

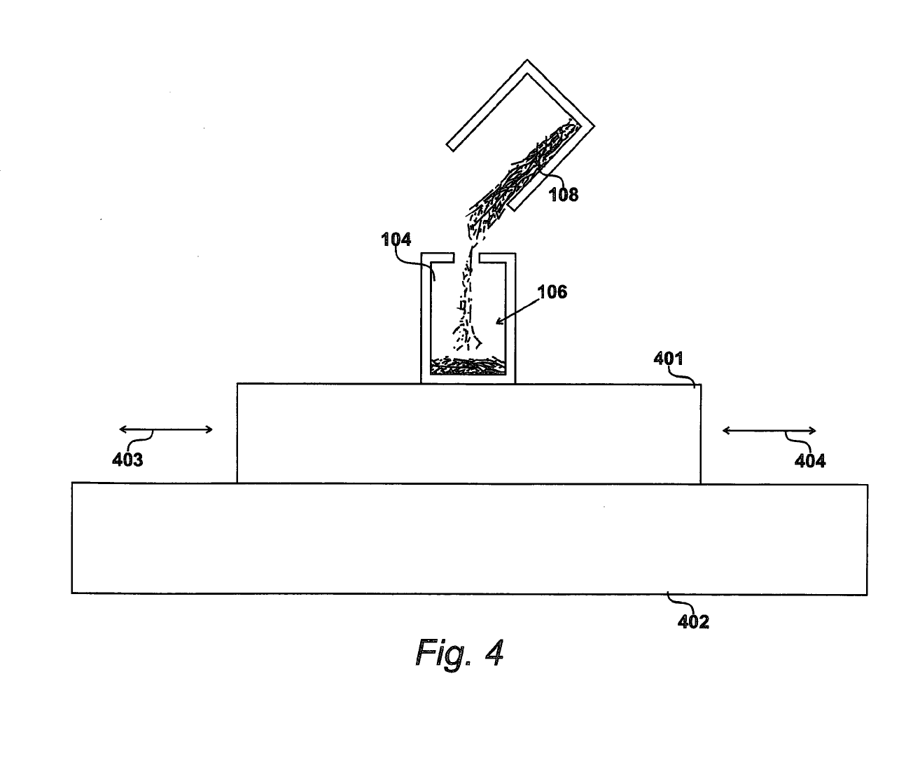

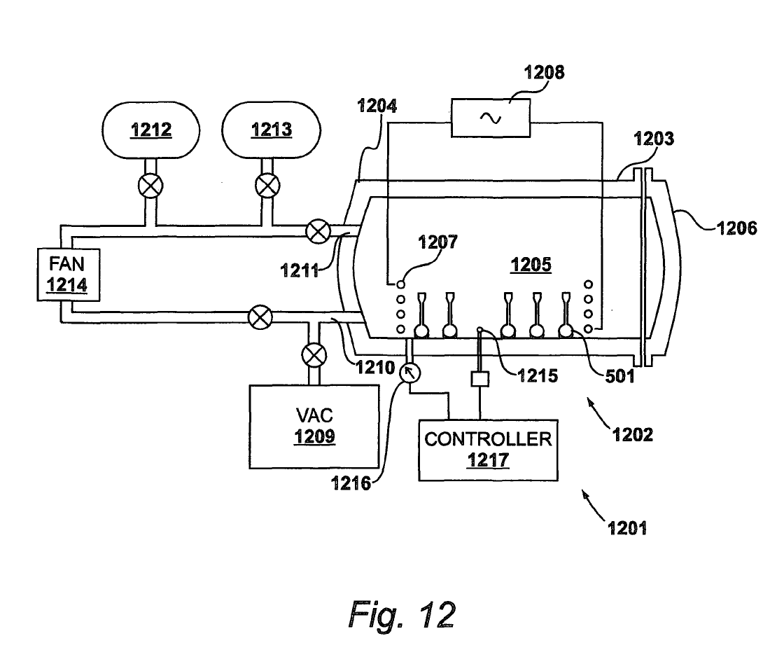

A method of forming a metal component from a powdered feed material is illustrated in FIG. 1. A feed material is initially in a powdered state (detailed in FIG. 4) and a solid component is formed by the application of heat (detailed in FIG. 12). At step 101 a sacrificial positive model 102 of a component is created. At step 103, a negative mould 104 is built around the positive model from a material having a melting point higher than the melting point of the material from which the component is to be formed (as detailed in FIG. 3).

At step 105 the sacrificial positive model is removed so as to leave a void 106 within the negative mould.

At step 107 feed material of metal powder 108 is deployed into the mould. At step 109 heat 110 is applied to the mould to a temperature higher than the melting point of the metal powder so as to cause the metal powder to melt within the mould, thereby establishing molten metal 111 within the mould 104.

The metal powder 108 used herein to form a metal component is, in a first embodiment, a powder consisting of particles of pure metal. However, in an alternative embodiment metal powder 108 is a powder comprising particles of an alloy. It should be appreciated therefore, that metal components formed from the said metal powder may be comprised either of a pure metal or an alloy compound.

Whereas metal powders need to be graded to specific size ranges for known powder metallurgy techniques, such as HIPping, powder metallurgy, metal injection moulding, etc, the method described herein is relatively insensitive to the size range of the powder particles. The only requirement is that the metal powder flows readily into the ceramic moulds. Where the mould defines sections having diameters as little as 0.5 millimetres, spherical powders produced by gas atomisation, for example, would be more appropriate. With larger mould sections, even angular powders produced by crushing and milling would enable the mould to be filled, especially when the flow of powder is aided by vibration, as will be described with reference to FIG. 4.

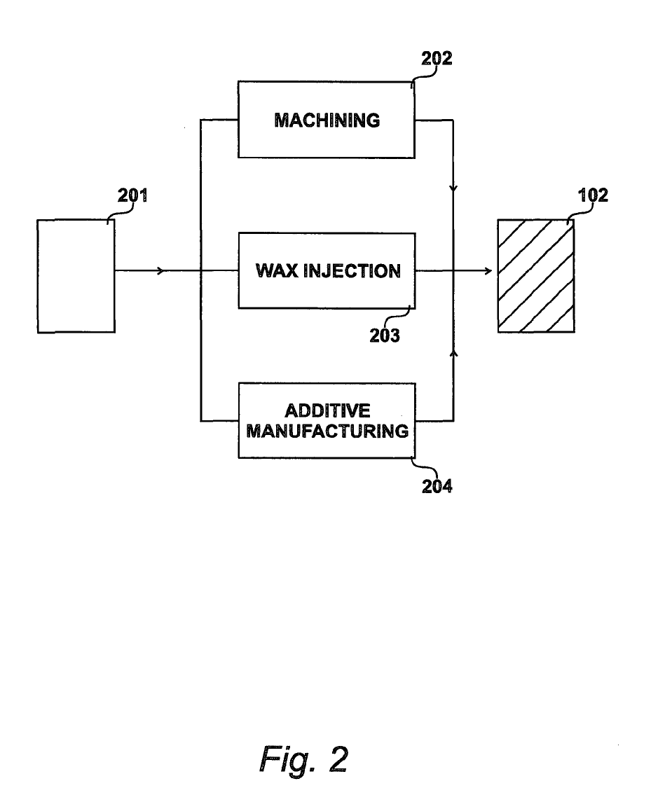

### FIG. 2

Procedures for the creation of the positive sacrificial model are illustrated in FIG. 2. Operations are performed upon a source material 201 in order to produce the positive model 102. In a first embodiment, it is possible to perform a machining operation 202 upon an appropriate material in order to define the shape of the positive model. However, it should be appreciated that the material used must be of a type such that it is possible to remove the sacrificial material in order to define the negative mould.

As an alternative, it is possible to perform a wax injection process 203. Having created a mould around the wax positive, it is possible to remove the wax by the application of heat. Such an approach is known in conventional casting systems where the heating of the mould is also desirable prior to the application of molten metal. However, in an embodiment, the mould would be allowed to cool and the particulates would be added at room temperature.

As an alternative, it is also possible to produce the positive mould by a process of additive manufacturing 204, with an appropriate rapid prototyping material for example. The material may be removed by the application of heat and/or the application of an appropriate solvent.

### FIG. 3

In the embodiment, the negative mould, having a melting point higher than the melting point of the metal from which the component is to be formed, is a ceramic shell that is relatively porous to air. In an embodiment, the ceramic mould is produced by adding a plurality of layers, as shown in FIG. 3.

In the embodiment shown in FIG. 3, layers are added as an alternating wet slurry layer followed by a substantially dry stucco layer.

Slurry 301 is applied to the model 102. Dry stucco 302 is then applied that attaches itself to the wet slurry in order to build a layer.

This process is repeated, as shown generally at 303, resulting in the build up of a layer 304. Thus, further repetitions are made until the negative mould 104 has been built to the required thickness. Ceramic mould 104 should ideally have relatively thin wall sections so as to allow the conduction of radiant heat from a radiant heating system therein, to enable the metal powder to be melted. However, the wall sections must be sufficiently thick to prevent cracks or fracturing during processing, and therefore a compromise must be reached in creating a mould that has a high thermal conductivity, but is sufficiently strong.

In an embodiment, a primary refractory slurry is applied that is inert to the metal being used. A dry sand of similar or different material is then applied and further slurries are applied, followed by sand, stucco and so on.

A number of suitable ceramic materials for forming the ceramic shell are known, such as silica and alumina. It has been found during testing that a silica shell does not have a sufficiently high thermal conductivity to allow the powder metal charge to be melted in a suitable time-frame using a radiant heating system. Therefore, in a preferred embodiment, a negative mould comprised of an alumina material having a high thermal conductivity is used. Other types of shell material having a high thermal conductivity may be used, however they must not be susceptible to dissolution in the molten metal as can be experienced by graphite based moulds when used certain metals.

### FIG. 4

Step 107 for the deployment of feed material is detailed in FIG. 4. The positive sacrificial model 102 has been removed as illustrated by step 105. The negative mould 104 is placed upon a vibrating table 401, itself supported by a stable base 402. In this way, as the feed material 108 is deployed into the mould 104, or after deployment, a degree of vibration is introduced, as illustrated by arrows 403 and 404, to facilitate the dispersal of the feed material within the mould. High frequency vibration, e.g. 40-60 hertz, with low amplitude displacement of, say, 0.10-0.15 millimetres enables moulds for large and complex metal components to be filled easily.

Thus, the feed material is deployed within the mould and then heated, as illustrated by step 109. In an embodiment, the heat is applied without pressure and the mould is heated to a temperature that causes the feed material to melt. In this way, it is possible to obtain close to 100 percent density using a process that has less overall complexity compared to known systems. The heat is required not only to raise the temperature of the metal, but also to melt the metal completely. Consequently, it is typically heated to around 50 degrees Celsius above the melting point of the metal, in the case of a pure metal, or above the liquidus temperature in the case of an alloy.

In some known systems, contamination is often introduced from containers and this is a particular problem when using titanium. Processes using solid state diffusion result in the container experiencing a similar environment to the material contained inside. Thus, even after machining away, it is possible that a significant layer of a material mixture will remain. Consequently, additional processing is required in order to achieve the required result.

It has been recognised that the use of metal powder as a feed material may produce products having desirable properties. There is a tendency for the microstructure to be very uniform, which may improve strength and fatigue properties. Properties of this type may be provided by forging operations but, as is known, forging results in the production of significant levels of waste and therefore increases overall cost. Similarly, a casting process yield is typically 50 percent; again increasing cost, which becomes an important factor when expensive alloys are being used.

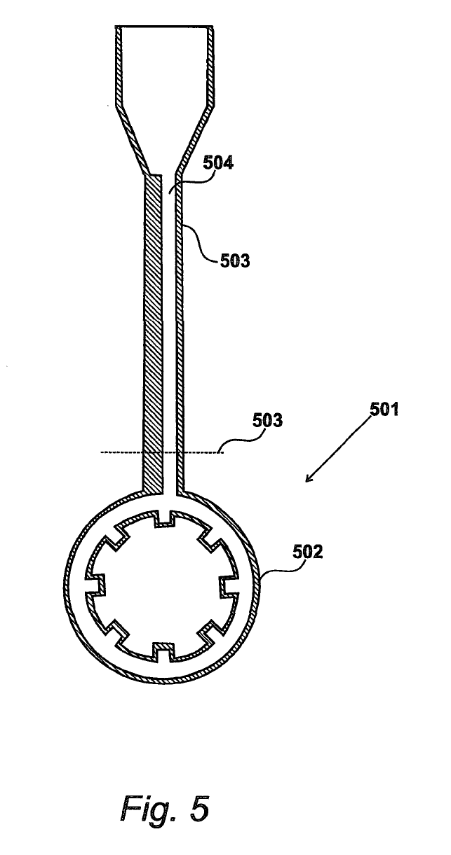

### FIG. 5

An apparatus for forming a metal component from a powdered feed material is illustrated in FIGS. 5 through 12. As previously described, a sacrificial positive model is created and a negative mould is built around the positive model from a material having a melting point higher than the melting point of the metal from which the material is formed. Thus, this results in the creation of a negative mould, preferably a ceramic mould 501.

The sacrificial positive model is removed from the negative mould 501. The apparatus further comprises a deploying device for deploying the feed material of metal powder into the mould 501, and a heating system for heating the metal powder to a temperature higher than the melting point of the metal powder so as to cause the metal powder to melt within the mould.

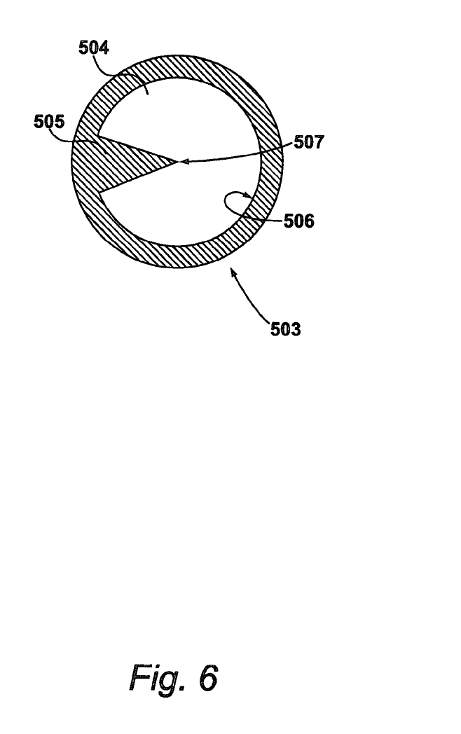

An example of a mould 501 is illustrated in FIG. 5 in cross-section. The mould 501 includes a component section 502 corresponding to the component to be produced and a feeder section 503. The feeder section 503 defines a generally cylindrical passageway 504, that may include an inwardly extending element as detailed in FIG. 6. The feeder section adjoins said component section at a first end and extends vertically upwards towards a distal end that is open to allow insertion of feed materials up to a head level.

The feeder section is provided because when metals cool from their molten liquid state, their volume decreases as the temperature drops to the point where they are solid. Thus, the feeder is used to provide additional liquefied metal to the mould to compensate for the shrinkage cavities that would otherwise form at one or more thermal centres in the interior of the casting as it cools. The volume of the feeder is therefore determined by the requirement for sufficient liquid metal to be provided in order to compensate for the volume reduction of the metal as it cools. Two factors influence the efficiency of feeding; firstly, the metallostatic pressure in the feeder, and secondly the pressure being applied to the liquid metal surface of the feeder by the surrounding atmosphere. The metallostatic pressure head in the feeder assists in forcing the molten metal into the mould section, as metal contained in the mould section cools and decreases in volume.

The head of molten metal should remain molten at least until the metal in the component section has solidified completely. To inhibit the conduction of thermal energy from within the feeder section to outside the feeder section during cooling and to thereby maintain the metal in the feeder in its molten state, the walls of the feeder section should have a relatively lower thermal conductivity than the walls of the component section. The feeder section may therefore be comprised of a different ceramic material to said component section and may comprise insulating or exothermic ceramic powders. Alternatively, the feeders may be wrapped in insulating material to ensure they solidify later than the metal component and to ensure that the surface of the molten metal in the feeder head remains molten so that any atmospheric pressure effects will assist in feeding.

To maximise the metallostatic pressure, the feeder head should be raised as high as is practically and economically feasible in order to maximise the metallostatic pressure,

To further improve the degassing of molten metal in the component section and to increase the pressure applied to the molten metal, one or more atmospheric cores may be provided extending downwardly through the feeder section towards the component section. These atmospheric cores may be pencil shaped ceramic tubes which are porous to gasses and whose permeability allows atmospheric pressure to be applied to the liquid metal in the thermal centre of the feeder section, and to allow gas trapped within the liquefied metal to escape. A particular atmospheric core in the form of an inwardly extending element is described further with reference to FIG. 6.

In an embodiment, the ceramic mould is initially at room temperature, therefore it is at a known and relatively constant temperature; compared to situations where the mould may have been heated and the actual temperature of the mould, when material may be added, may fall within a relatively wide range of possible temperatures. However, in an embodiment where the temperature is known in terms of an initial temperature and a melt temperature, it is possible to accurately calculate the volume of powder required in the feeders. Thus, an optimum amount of material may be held in the feeders so as to compensate for the 30-35 percent contraction in volume during the overall process.

A cross-sectional view of the mould through horizontal plane 503 is illustrated in FIG. 6.

### FIG. 6

The feeder section 503 defines a generally cylindrical passageway 504. The passageway 504 includes an atmospheric core, here provided by inwardly extending element 505 that is porous to gasses and extends inwardly from the generally cylindrical inside surface 506 of the passageway 504 defined by the feeder towards the middle of the cylindrical passageway. In an embodiment, the inwardly extending element 505 is substantially wedge-shaped, having faces arranged at an acute angle to each other, to form a sharp edge 507 close to the middle of passageway 504 and is formed of the same porous material from which the feeder is formed.

In an embodiment the mould is located within the chamber of a vacuum furnace in order to melt the metal powder within the mould. During this process, the inwardly extending element provides a means for allowing the atmosphere in the chamber to access molten metal in the feeder during cooling of the metal component, to allow gas trapped within the molten material to be released. The inwardly extending element therefore functions as an atmospheric core whose permeability allows pressure to be applied to the liquid metal in a thermal centre of the feeder head and to allow gas to escape from the molten metal in the component and feeder sections of the mould.

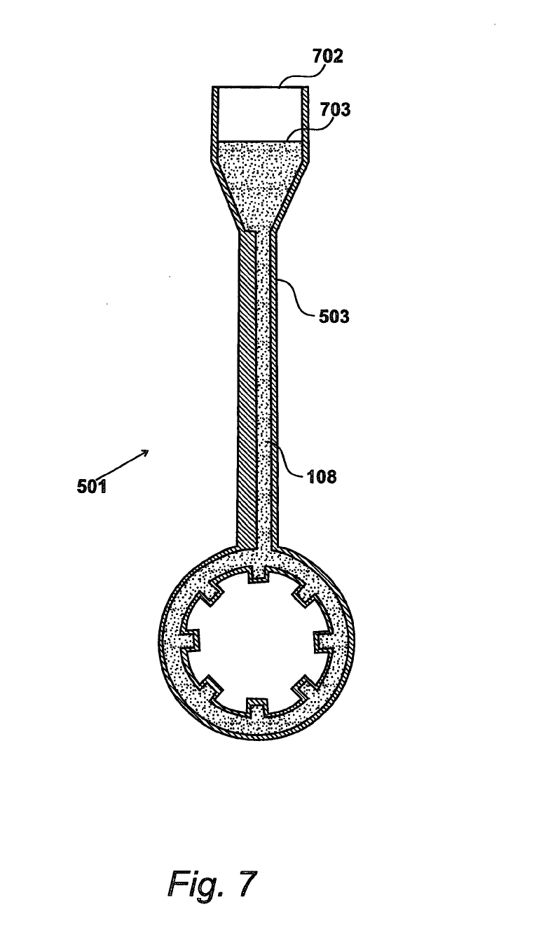

### FIG. 7

Mould 501 is shown in FIG. 7, after being loaded with metal powder 108 during process 107. The metal powder has been poured into an open end 702 of the feeder 503 up to a head level, and vibrated (as described with reference to FIG. 4) to compact the metal powder 108. In an embodiment, the feeder is filled with metal powder to the top of said feeder. The mould is then vibrated, resulting in the upper surface 703 of the metal powder in the feeder becoming lower, when compared to the level of the powder before vibration.

In an embodiment, the metal powder is formed from substantially spherical particles. Consequently, even after compaction by vibration, approximately 25-30 percent of the volume taken up by the powder 108 comprises voids between the particles. In an alternative embodiment, other shapes of particles may be deployed, either alone or in combination with spherical partials. The inclusion of particles of this type may decrease the volume taken up by voids within the powder.

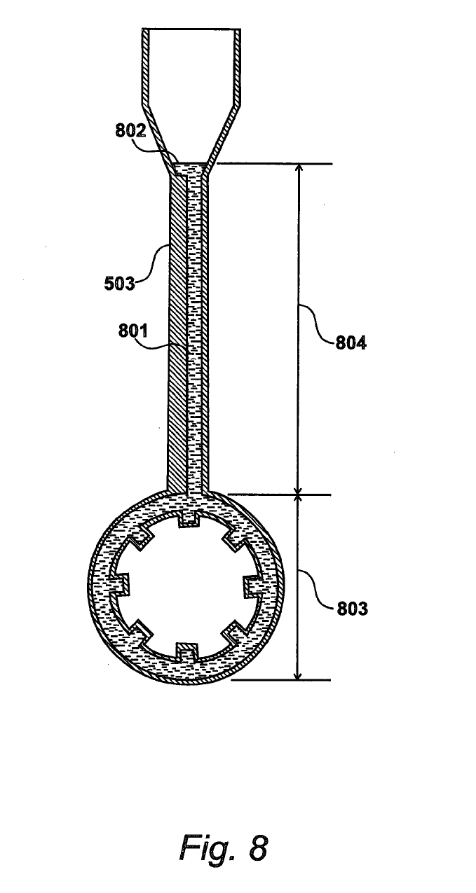

### FIG. 8

Mould 501 is shown in FIG. 8, after the metal powder 108 has melted to form a liquid metal 801. An upper surface 802 of the liquid metal has gone down the feeder when compared to the surface 703 of the powder. However, in this embodiment, the height of the molten metal 801 in the feeder is greater than twice the height of the section of the mould corresponding to the metal object being produced. The height of the component section of the mould corresponding to the component to be produced is indicated by arrow 803 and the height of the molten metal 801 in the feeder section 503 is indicated by arrow 804. Thus, in this embodiment, the height indicated by arrow 804 is more than twice the height of that indicated by arrow 803.

A pressure is created within the molten metal due to the weight of molten metal in the feeder. By introducing a relatively high feeder of molten metal, sufficient pressure may be produced in the molten metal within the mould to ensure that the molten metal is forced into fine details of the mould surface.

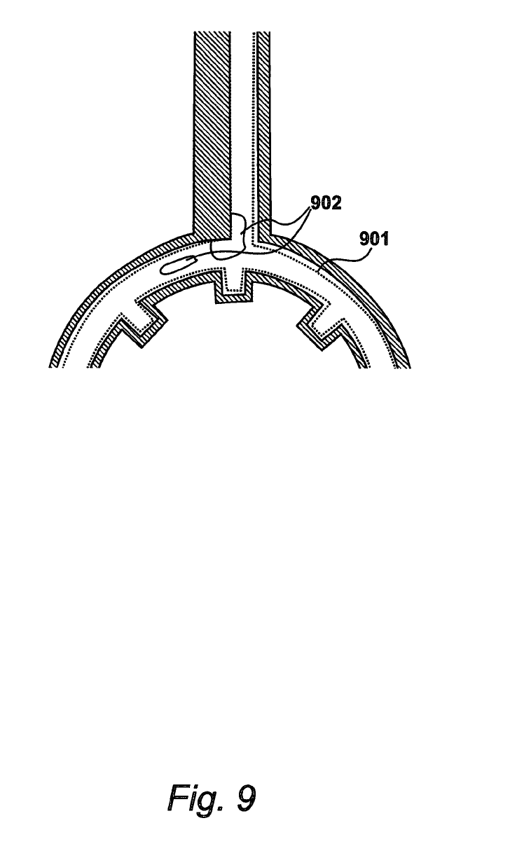

### FIG. 9

A partial cross-sectional view of the mould 501 is illustrated in FIG. 9. As the mould cools, heat is conducted from the molten metal through the walls of the mould. Consequently, the outside of the molten metal tends to solidify first, with the solidification process continuing in an inward direction.

In the example of FIG. 9, region 901, adjacent to the walls of the mould, is in the process of crystallizing, whereas portions of the metal away from the walls are still liquid. During solidification, the metal contracts typically by about 7 percent by volume and consequently voids 902 form within the molten metal.

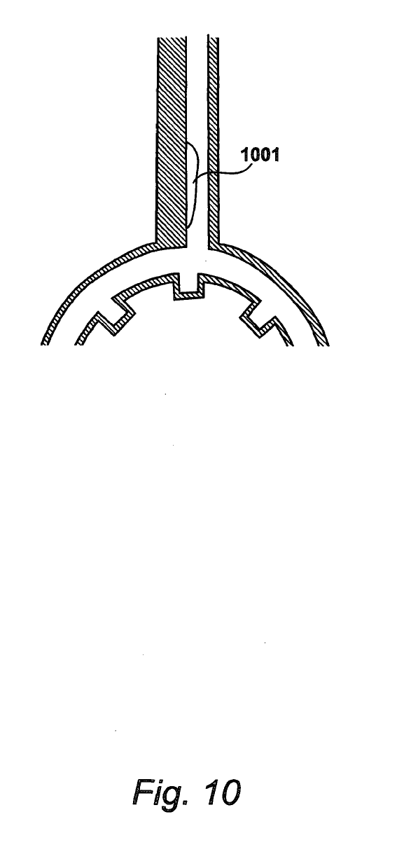

### FIG. 10

When voids are surrounded by molten metal, metal will tend to fall into the void under gravity, resulting in voids appearing to rise up the mould.

In an embodiment, the feeder is arranged such that the voids rise into the feeder and metal within the feeder falls into the mould to ensure that the mould is completely filed.

In the example shown in FIG. 10, voids 902 have coalesced to form a single void 1001 that has risen up to the feeder.

Generally, voids, such as void 1001, will define a volume of space containing a vacuum. However, these voids may contain some gas that has become trapped by the molten metal within the mould. In an embodiment, the inwardly extending element 505 provides a means for allowing gas trapped within the molten metal in the feeder to escape. The inwardly extending element is able to do this because it is a relatively good insulator of heat (compared to the metal itself) and it extends into the molten core of the metal within the feeder. Furthermore, the element is porous to gases.

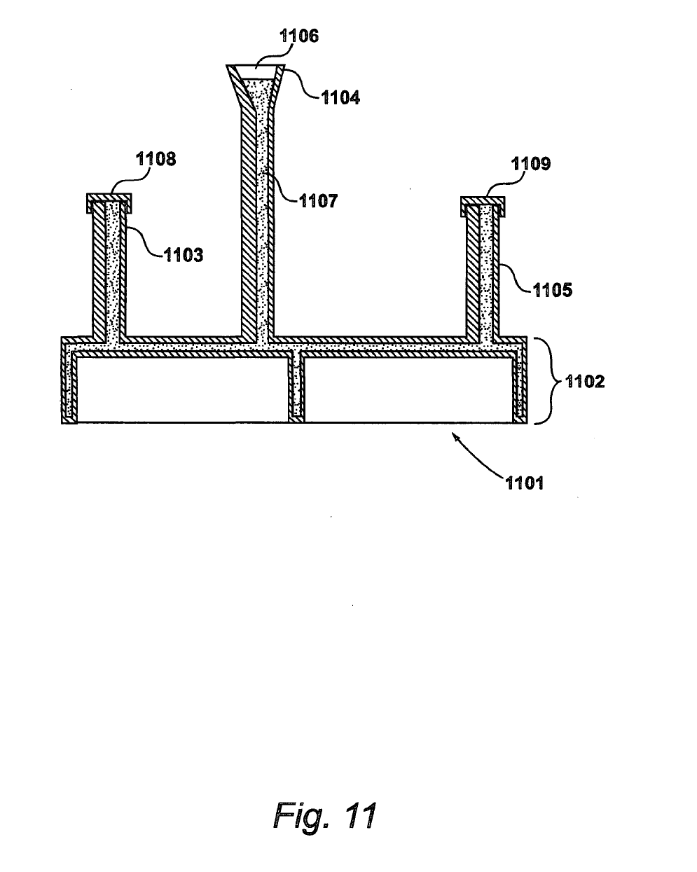

### FIG. 11

The mould described with reference to FIGS. 5 through 10 has a single feeder that provides a means of receiving powder into the mould, while also providing a metallostatic head for producing an elevated metallostatic pressure in the mould. However, in an alternative embodiment, one or more additional feeders may be provided; separate from the feeder providing the metallostatic head pressure.

An example is shown in FIG. 11 in which a mould 1101 has a lower section 1102 corresponding to the metal object to be produced. In addition, the mould has a first feeder 1103, a second feeder 1104 and a third feeder 1105.

The second feeder 1104 is substantially similar to the feeder 503 shown in FIG. 5, having a height that is more than twice the height of section 1102 and providing an opening 1106 at its upper end for receiving powdered metal 1107.

The first feeder 1103 and the third feeder 1105 are similar to feeder 1104 but differ in that their heights are substantially less than the height of the second feeder 1104. Furthermore, their upper ends have been capped such that said ends are completely sealed.

The first feeder 1103 and the third feeder 1105 contain powdered metal for feeding section 1102. They also define a passageway, for receiving voids formed in the molten metal during the cooling process. However, the metallostatic pressure is provided by the second feeder 1104. Initially open feeders may be formed on moulds and subsequently sealed by a cap that is cemented in place. Alternatively, the feeders may be formed during the manufacture of the mould with a sealed upper end.

### FIG. 12

An embodiment of an apparatus for forming a metal component from a powdered feed material is shown in FIG. 12. In the embodiment, the induction heating system includes a source of electromagnetic energy, such as coil 1207 for generating radio frequency energy from an electrical supply, along with a control circuit for controlling the electrical supply in order to control temperature. The apparatus further comprises a granular susceptor material, which is in this embodiment contained with the walls of moulds 501.

A granular susceptor is a preferred form of susceptor material as it enables the susceptor to be contoured to the shape of the mould to which heat is to be applied. In an embodiment a refractory tube is formed of a ceramic material in a shape corresponding to the shape of the mould it heats. The tube is then filled with a granular susceptance material which acts to radiate heat to the adjacent mould. This provides a very versatile susceptor element, which is not otherwise possible when using a solid susceptor ingot which is hard to machine to an appropriate shape. In a specific embodiment, discussed with reference to FIG. 14, the granular susceptor material forms a loose bed into which the mould is wholly immersed, thereby ensuring intimate contact between susceptor and mould and an efficient transfer of thermal energy.

An embodiment of the invention further includes pressure reduction apparatus configured to reduce the pressure of a chamber to a pressure below atmospheric pressure. An example of this apparatus is shown in FIG. 12. Pressure reduction is desirable in order to reduce contamination from the surrounding atmosphere. However, although extremely low pressures are possible, vapour pressure is required within the chamber in order to prevent evaporation of the molten material.

The apparatus, indicated generally at 1201, has a vacuum furnace 1202. The vacuum furnace has a vacuum-tight vessel 1203, with a refractory lining 1204, defining a vacuum chamber 1205.

Vessel 1203 is provided with a door 1206, for the purpose of providing access to the chamber 1205, thereby allowing the chamber to be loaded and unloaded with moulds, such as mould 501.

In an embodiment, the vacuum furnace 1202 has a radio frequency coil 1207 connected to a suitable electrical power supply 1208. Typically, radio frequency coils are formed of molybdenum, but the full specification of the vacuum furnace will depend upon the specific types of metals and alloys that are being used in the process. Furthermore, the specification will also depend upon the requirements of the metal objects that are being formed.

In an embodiment, the vacuum furnace, its radiation source and power supply are selected such that the temperature of the chamber may be raised to a temperature in excess of 2000 degrees Celsius. Furnaces with these capabilities are commercially available, generally for the purpose of providing heat treatment operations.

Chamber 1205 is connected to a vacuum system 1209 for evacuating air from the chamber, such that pressures in the chamber may be reduced to levels substantially below atmospheric pressure.

The chamber 1205 has an inlet port 1211 connected to a noble gas supply. In an embodiment, a tank 1212 of compressed helium may be provided in combination with a tank 1213 of compressed argon.

The apparatus 1201 also includes a fan 1214 having an inlet connected to outlet port 1210 of chamber 1205 and an outlet connected to the inlet port 1211. In an embodiment, helium gas is supplied to the chamber 1205 up to a predetermined pressure and the gas is circulated by the fan 1214 to provide a cooling draft over the moulds contained in the chamber.

Temperature sensors 1215 are located within the chamber and in preferred embodiments placed in contact with the moulds so as to provide signals indicative of an actual temperature of the powdered or molten metal in the moulds located within the chamber. The apparatus also includes a vacuum pressure gauge 1216 configured to provide an indication of vacuum pressure within the chamber.

In an embodiment, the pressure gauge 1216 and the temperature sensor 1215 are arranged to provide signals to a controller 1217 indicative of the pressure and temperature of the chamber. The controller is arranged to operate the power supply 1208 for the resistance heating element 1207 and the vacuum system 1209, in response to the signals received from gauge 1216 and sensor 1215. In an embodiment, controller 1217 is a programmed computer system or a microcontroller.

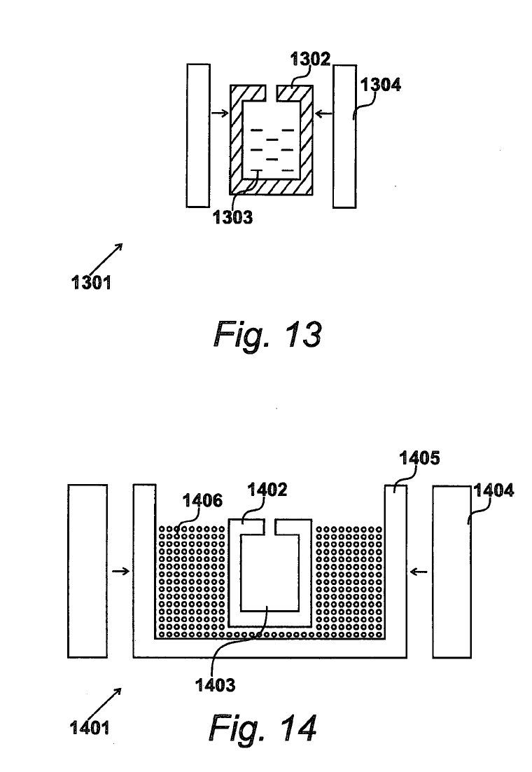

### FIG. 13

An alternative embodiment of the present invention is illustrated at 1301 in FIG. 13. To form a metal component, a mould 1302 is filled with metal particles 1303. A source 1304 of electro-magnetic radiation is provided and a susceptance material is configured to be heated in response to receiving electro-magnetic radiation and to thermally heat the metal particles 1303. It has been determined that when heating a metal powder in a ceramic mould using induction heating, the induction field couples too weakly with the powder metal itself to melt it. The ceramic mould of the present invention, unlike a conventional metal mould is relatively transparent to the induction field and is therefore not itself heated. Therefore, when heating using an induction field, a radiant susceptor is preferred. The susceptor is chosen to be of a material so that it absorbs the energy of the induction field and radiates infra-red energy towards the ceramic mould. This causes the ceramic mould to be heated, which in turn heats the metal powder contained within.

In an embodiment, the electro-magnetic radiation is microwave radiation and said apparatus further comprises a source of microwave radiation, in the form of a microwave generator. Microwave radiation is a preferred type of energy as it is efficiently generated and easily guided. When using microwave energy a preferred susceptor material is silicon carbide. Silicon carbide is less prone to thermal degradation than many other susceptor materials and it can typically be heated to temperatures in excess of 3000 degrees Celsius. In the embodiment shown at 1301, the granular susceptance material is included in the mould 1302 itself however, it is possible for a granular susceptor mass to be provided separately, in a configuration substantially similar to that shown in FIG. 14.

### FIG. 14

An alternative embodiment for forming a metal component is shown at 1401. A mould 1402 receives metal particles 1403. A source 1404 emits electro-magnetic radiation directed towards a container 1405. The container 1405 is substantially transparent to the radiation emitted by source 1404 and a susceptance material 1406 is included, within container 1405 that surrounds the mould 1402. In the illustrated embodiment, the susceptance material 1406 is a granular particulate material comprised of particles of silicon carbide. A granular susceptance material is preferred in some applications as it allows suscepted heat to be applied intimately to the mould. In the illustrated embodiment, container 1405 is filled with particles 1406 of the susceptance material and mould 1402 is placed in the container so as to be partially or wholly immersed in granular susceptance material 1406. By immersing mould 1402 in susceptance material 1406 not only is thermal energy efficiently transferred from the susceptance material 1406 to the surface of mould 1402, but also mould 1402 is supported by susceptance material 1406, thereby reducing the risk of the mould fracturing when loaded with metal powder 1403.

1. A method of forming a metal component from a powdered feed material, comprising the steps of:
creating a negative mould of a component from a ceramics material having a melting point that is higher than the melting point of said powdered feed material;
deploying said feed material of metal powder into said mould;
locating said mould in a vacuum chamber having an induction heating system, said induction heating system comprising a source of electromagnetic energy and a granular susceptance material; and
heating said mould using said induction heating system to a temperature higher than the melting point of the metal powder so as to melt said metal powder within the mould; wherein
said granular susceptance material absorbs the energy of the induction field generated by said source of electromagnetic energy and radiates infra-red energy towards the ceramic mould.

2. The method of claim 1, wherein said negative mould is built about a sacrificial positive model of the component.

3. The method of claim 2, wherein said step of building said negative mould consists of adding a plurality of layers to the outside of said positive model.

4. The method of claim 1, wherein said step of heating said mould using said induction heating system comprises the step of generating microwave energy.

5. The method of claim 1, wherein said granular susceptance material is comprised of particles of silicon carbide.

6. The method of claim 3, wherein said plurality of layers comprises a primary refractory slurry that is inert to said powdered feed material.

7. The method of claim 3, wherein the plurality of layers are applied as an alternating wet slurry layer followed by a substantially dry stucco layer and said alternating slurry layers and stucco layers contain substantially similar ceramic material.

8. The method of claim 1, further comprising the step of feeding additional liquefied metal into said mould as said mould cools and the metal contained within said mould contracts.

9. The method of claim 8, further comprising the step of feeding said additional liquefied material into a feeder section up to a head level to assist in forcing molten metal into the mould during cooling.

10. The method of claim 9, further comprising the step of providing an atmospheric core to said feeder section and allowing gas trapped within said liquefied metal to escape via said atmospheric core.

11. An apparatus for forming a metal component from a powdered feed material, comprising:
a negative mould of a component comprised of a ceramics material having a melting point higher than the melting point of said powdered feed material contained therein; and
a vacuum chamber for receiving said mould, the vacuum chamber having an induction heating system comprising a source of electromagnetic energy and a granular susceptance material, wherein
said granular susceptance material is configured to absorb the energy of the induction field generated by said source of electromagnetic energy and radiate infra-red energy towards the ceramic mould.

12. The apparatus of claim 11, further comprising a sacrificial positive model of the component to be formed about which said negative mould is built.

13. The apparatus of claim 11, wherein said granular susceptance material is comprised of particles of silicon carbide.

14. (canceled)

15. The apparatus of claim 11, wherein said source of electromagnetic energy comprises a source of microwave radiation.

16. The apparatus of claim 11, wherein said negative mould is comprised of an alumina material having a high thermal conductivity.

17. The apparatus of claim 11, wherein the negative mould defines a component section corresponding to the metal component being produced and a feeder section for feeding additional liquefied metal into said component section as said mould cools and the metal contained within contracts.

18. The apparatus of claim 17, wherein said feeder section extends vertically upwards from said component section and the difference in height between the top of said component section and said head level is more than twice the height of said component section.

19. The apparatus of claim 17, wherein said feeder has a first end adjoining said component section and a distal end extending therefrom and open to allow insertion of feed materials up to said head level.

20. The apparatus of claim 17, wherein said feeder section comprises an atmospheric core that is porous to gasses for allowing gas trapped within the liquefied metal in said feeder section to escape.
